(19) United States
(12) Patent Application Publication
(10) Pub. No.: US 2021/0104860 A1
(43) Pub. Date: Apr. 8, 2021

(54) LASER SYSTEM AND METHOD OF CONTROLLING A LASER DEVICE

(71) Applicant: Fanuc Corporation, Minamitsuru-gun (JP)

(72) Inventors: Wataru Hanakawa, Minamitsuru-gun (JP); Hiroaki Tokito, Minamitsuru-gun (JP)

(73) Assignee: Fanuc Corporation, Minamitsuru-gun (JP)

(21) Appl. No.: 17/016,797

(22) Filed: Sep. 10, 2020

(30) Foreign Application Priority Data
Oct. 2, 2019 (JP) 2019-182333

(51) Int. Cl. H01S 3/067; B23K 26/06; H01S 3/00

(52) U.S. Cl. CPC H01S 3/067; H01S 3/0014; B23K 26/0665

(57) ABSTRACT

A laser system preventing a light-guiding member that guides a laser beam from being overheated is provided. A laser system includes a laser device including a resonator section configured to generate a laser beam and a light-guiding member configured to guide the laser beam generated by the resonator section, a detection device configured to detect, as a detection value, a temperature of the laser device or a magnitude of the laser beam guided by the light-guiding member, an emission control section configured to stop emission of the laser beam from the resonator section to the light-guiding member when the detection value exceeding a predetermined threshold, and a stop-time determination section configured to determine a stop time for causing the emission control section to stop emission of the laser beam based on the detection value detected by the detection device.

### BACKGROUND OF THE INVENTION

### 1. Field of the Invention

The present invention relates to a laser system and a method of controlling a laser device.

### 2. Description of the Related Art

There is known a laser system that detects an abnormal operation by monitoring a temperature of a component (e.g., JP 2011-240361 A). In the related art, in a laser system, it has been a defect that a light-guiding member that guides a laser beam becomes overheated.

### SUMMARY OF THE INVENTION

In an aspect of the present disclosure, a laser system includes a laser device including a resonator section configured to generate a laser beam and a light-guiding member configured to guide the laser beam generated by the resonator section; a detection device configured to detect, as a detection value, a temperature of the laser device or a magnitude of the laser beam guided by the light-guiding member; an emission control section configured to stop emission of the laser beam from the resonator section to the light-guiding member when the detection value exceeds a predetermined threshold; and a stop-time determination section configured to determine a stop time for causing the emission control section to stop the emission of the laser beam based on the detection value detected by the detection device.

In another aspect of the present disclosure, a method of controlling a laser device including a resonator section configured to generate a laser beam and a light-guiding member configured to guide the laser beam generated by the resonator section, the method including detecting, as a detection value, a temperature of the laser device or a magnitude of the laser beam guided by the light-guiding ember; stopping emission of the laser beam from the resonator section to the light-guiding member when the detection value exceeds a predetermined threshold; and determining a stop time for stopping the emission of the laser beam from the resonator section based on the detected detection value.

According to the present disclosure, when the detection value exceeds the threshold, the emission of the laser beam is stopped over the determined stop time, whereby it is possible to prevent the light-guiding member from being overheated and causing a defect (deformation, melting, or the like) in the light-guiding member. Further, by determining the stop time based on the detection value, the stop time can be automatically determined as an optimum time for cooling the light-guiding member.

### BRIEF DESCRIPTION OF THE DRAWINGS

FIG. 1 is a diagram of a laser system according to an embodiment.

FIG. 2 is a flowchart illustrating an example of an operation flow of the laser system.

FIG. 3 is a diagram illustrating a temporal change in the temperature of the light-guiding member.

FIG. 4 is a diagram of a laser system according to another embodiment.

FIG. 5 is a diagram of a laser system according to yet another embodiment.

FIG. 6 is a diagram of a laser system according to yet another embodiment.

FIG. 7 is a diagram of a laser device according to an embodiment, and illustrates a cross-sectional view of an optical fiber in a region B.

FIG. 8 is an enlarged cross-sectional view of a main part of the laser device illustrated in FIG. 7.

FIG. 9 is a diagram of a laser device according to another embodiment.

FIG. 10 is an enlarged cross-sectional view of a main part of the laser device illustrated in FIG. 9.

FIG. 11 is a diagram illustrating another function of the laser system illustrated in FIG. 1.

### DETAILED DESCRIPTION

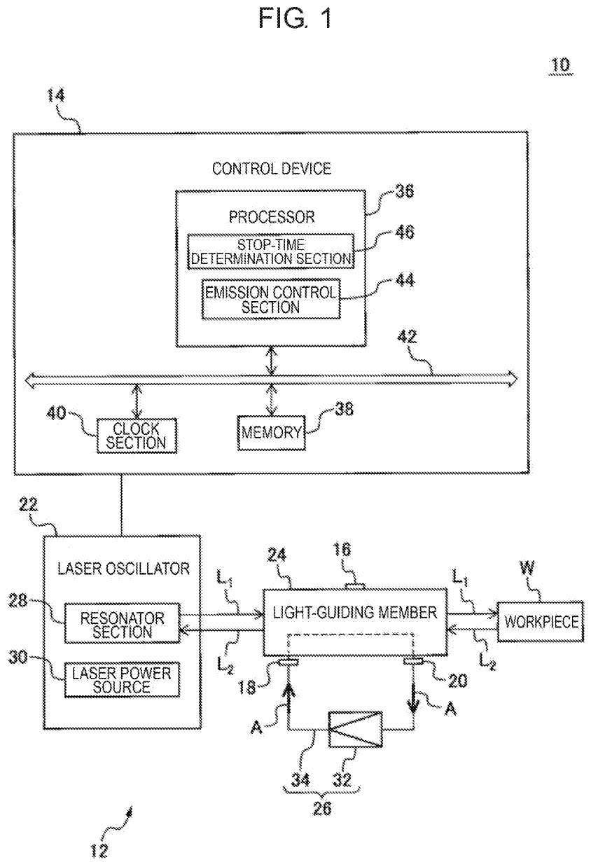

Hereinafter, embodiments of the present disclosure will be described in detail with reference to the drawings. In the various embodiments described below, similar elements are denoted by the same reference numerals, and redundant description thereof will be omitted. First, a laser system 10 according to an embodiment will be described with reference to FIG. 1. The laser system 10 is a laser-processing system that performs laser-processing on a workpiece W by irradiating the workpiece W with a laser beam L₁.

The laser system 10 includes a laser device 12, a control device 14, and temperature sensors 16, 18 and 20. The laser device 12 includes a laser oscillator 22, a light-guiding member 24, and a cooling device 26. The laser oscillator 22 is a gas laser oscillator (e.g., a carbon dioxide laser oscillator), a solid-state laser oscillator (e.g., a YAG laser oscillator or a fiber laser oscillator), or the like, and generates a laser beam and emits it to the light-guiding member 24.

Specifically, the laser oscillator 22 includes a resonator section 28 and a laser power source 30. The resonator section 28 generates a laser beam therein by optical resonance, and emits it to the light-guiding member 24 as the laser beam L₁. The laser power source 30 supplies power for the laser beam generation operation by the resonator section 28 to the resonator section 28, in response to a command from the control device 14. The light-guiding member 24 includes an optical element such as an optical fiber, a light guide path, a reflection mirror, or an optical lens, and guides the laser beam L₁ generated by the resonator section 28 toward the workpiece W.

The cooling device 26 cools the light-guiding member 24. Specifically, the cooling device 26 includes a flow device 32 (a pump or the like) and a coolant flow path 34. The coolant flow path 34 is a closed flow path provided in contact with the light-guiding member 24 so as to pass through the light-guiding member 24, wherein a coolant (e.g., water) is sealed in the coolant flow path 34. The coolant flow path 34 is defined by e.g. a tube connected to the light-guiding member 24 and a hole formed in the light-guiding member 24.

The flow device 32 causes the coolant in the coolant flow path 34 to flow in the direction of arrow A in FIG. 1, in response to a command from the control device 14. For example, the flow device 32 includes a rotor disposed inside the coolant flow path 34 and a motor (both not illustrated) that rotates the rotor. The coolant flowed by the flow device 32 flows into the light-guiding member 24, passes through the light-guiding member 24, and then flows out of the light-guiding member 24. The light-guiding member 24 is cooled by the coolant circulating in the coolant flow path 34 in this way.

The temperature sensor 16 is provided at the light-guiding member 24 and detects the temperature T₁ of the light-guiding member 24 as a detection value. Therefore, in the present embodiment, the temperature sensor 16 constitutes a detection device configured to detect the temperature T₁ of the laser device 12 (specifically, the light-guiding member 24) as a detection value. The temperature sensor 18 is provided at a position on the upstream side of light-guiding member 24 in the coolant flow path 34, and detects a temperature T₂ of the coolant flowing into the light-guiding member 24. On the other hand, the temperature sensor 20 is provided at a position on the downstream side of light-guiding member 24 in the coolant flow path 34, and detects a temperature T₃ of the coolant flowing out of the light-guiding member 24. The temperature sensors 16, 18 and 20 each include e.g. a thermocouple, a thermopile, a thermistor, or platinum temperature measuring resistor.

The control device 14 controls the laser beam generation operation of the laser oscillator 22 and the cooling operation of the cooling device 26. Specifically, the control device 14 includes a processor 36, a memory 38, and a clock section 40. The processor 36 includes a CPU, a GPU, or the like, and is communicably connected to the memory 38 and the clock section 40 via a bus 42. The processor 36 executes arithmetic processing for various functions described later. The memory 38 includes a ROM, a RAM, or the like, and stores various data. The clock section 40 clocks an elapsed time from a certain time point.

The laser beam L₁ generated by the resonator section 28 is guided by the light-guiding member 24 and irradiated onto the workpiece W₁, whereby the workpiece W₁ is laser-processed by the laser beam L₁. A part of the laser beam L₁ irradiated onto the workpiece W₁ is reflected by a surface of the workpiece W₁, and propagates toward the resonator section 28 through the light-guiding member 24 as a return beam L₂.

The laser beam L guided by the light-guiding member 24 (i.e., the laser beam L₁ and the return beam L₂) may cause heat generation of each component of the laser oscillator 22 and the light-guiding member 24. In the present embodiment, the control device 14 stops emission of the laser beam L₁ from the resonator section 28 to the light-guiding member 24 in order to prevent overheating of the components of the laser oscillator 22 and the light-guiding member 24.

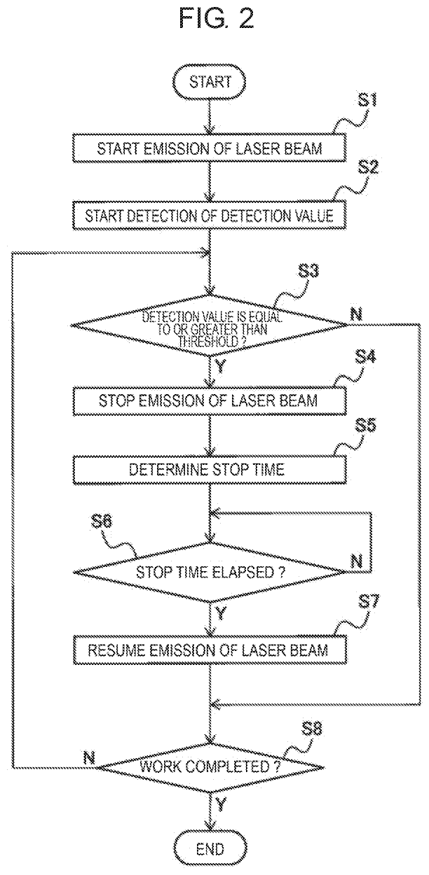

Hereinafter, the operation of the laser system 10 will be described with reference to FIG. 2. The flow illustrated in FIG. 2 is started when the processor 36 receives a work-start command from e.g. an operator, a host controller, or a computer program. In step S1, the processor 36 starts the emission of the laser beam from the resonator section 28 to the light-guiding member 24. Specifically, the processor 36 operates the laser power source 30 to supply the power to the resonator section 28. Upon reception of the power supply from the laser power source 30, the resonator section 28 generates the laser beam therein and emits the laser beam L₁ toward the light-guiding member 24.

In step S2, the processor 36 starts detection of the detection value T₁ by the temperature sensor 16. Specifically, the temperature sensor 16 consecutively (e.g., periodically) detects the temperature T₁ of the light-guiding member 24, and sequentially transmits the temperature T₁ as the detection value T₁ to the control device 14. Together with the detection of the detection value T₁, the processor 36 starts the temperature detection by the temperature sensors 16 and 18.

Specifically, the temperature sensor 18 consecutively (e.g., periodically) detects the temperature T₂ of the coolant at the position on the upstream side of light-guiding member 24, and sequentially transmits the detected temperature to the control device 14. Further, the temperature sensor 20 consecutively (e.g., periodically) detects the temperature T₃ of the coolant at the position on the downstream side of light-guiding member 24, and sequentially transmits the detected temperature to the control device 14. The processor 36 stores in the memory 38 the temperature T₁ (detection value), temperature T₂ and temperature T₃ acquired from the temperature sensors 16, 18, and 20.

In step S3, the processor 36 determines whether the most-recently acquired detection value T₁ exceeds a predetermined threshold Tₜₕ₁ (T₁≥Tₜₕ₁). The threshold Tₜₕ₁ is determined by the operator and stored in the memory 38 in advance. The processor 36 determines YES when T₁≥Tₜₕ₁ is satisfied and proceeds to step S4, while it determines NO when T₁<Tₜₕ₁ is satisfied and proceeds to step S8.

In step S4, the processor 36 stops the emission of the laser beam L₁ from the resonator section 28 to the light-guiding member 24. As an example, the processor 36 sends a command to the laser power source 30 to cut off the power supply from the laser power source 30 to the resonator section 28, thereby stopping the laser beam generation operation of the resonator section 28.

As another example, the laser oscillator 22 may further include a shutter (not illustrated) provided in an optical path of the laser beam L₁ between the resonator section 28 and the light-guiding member 24, and configured to open and block the optical path of the laser beam L₁. In this case, the processor 36 may stop the emission of the laser beam L₁ from the resonator section 28 to the light-guiding member 24 by closing the shutter, without stopping the laser beam generation operation of the resonator section 28.

Thus, in the present embodiment, the processor 36 functions as an emission control section 44 (FIG. 1) configured to stop the emission of the laser beam L₁ from the resonator section 28 to the light-guiding member 24 when the detection value T₁ exceeds the threshold Tₜₕ₁. When stopping the emission of the laser beam L₁ from the resonator section 28, the processor 36 activates the clock section 40 so as to start to clock an elapsed time t from the time point t₁ at which the emission of the laser beam L₁ from the resonator section 28 is stopped.

In step S5, the processor 36 determines a stop time tₛ for stopping the emission of the laser beam L₁ from the resonator section 28 to the light-guiding member 24, based on the most-recently acquired detection value T₁. Specifically, the processor 36 obtains the stop time tₛ by performing a predetermined calculation using the detection value T₁. Hereinafter, a calculation method for obtaining the stop time tₛ will be described.

First, the processor 36 calculates the heat amount Q accumulated in the light-guiding member 24 by the laser beam L (the laser beam L₁ and the return beam L₂) from the detection value T₁. As an example, the heat amount Q can be calculated from an equation: Q=C_{G}×T₁, using a heat capacity C_{G} of the light-guiding member 24 and the temperature T₁ (i.e., the detection value T₁) of the light-guiding member 24.

Then, the processor 36 calculates the heat dissipation amount J of the light-guiding member 24 by the cooling device 26, using the temperature T₂ detected by the temperature sensor 18 and the temperature T₃ detected by the temperature sensor 20. As an example, the heat dissipation amount J can be calculated from an equation: J=∫[C_{C}×(T₃−T₂)]dt, using the most-recently acquired temperatures T₂ and T₃ and a heat capacity C_{C} of the coolant. The integration time dt may be set as a predetermined arbitrary time (e.g., several milliseconds), or may be set as a time that coincides with the cycle time τ₃ (or an integer multiple of the cycle time τ₃: nτ₃) at which the temperature sensors 18 and 20 detect the temperatures T₂ and T₃.

Then, the processor 36 calculates the stop time tₛ from an equation: tₛ=Q/J (=C_{G}T₁/J[C_{C}×(T₃−T₂)]dt), using the heat amount Q and the heat dissipation amount J. In this manner, the processor 36 obtains and determines the stop time tₛ by the calculation described above. Therefore, in the present embodiment, the processor 36 functions as the stop-time determination section 46 (FIG. 1) configured to determine the stop time tₛ based on the detection value T₁. Note that the calculation of the stop time tₛ is not limited to the example using the above-described equations, but may be performed using any other equation. The equation used for calculating the stop time tₛ can be arbitrarily defined by the operator.

In step S6, the processor 36 determines whether the elapsed time t clocked by the clock section 40 has reached the stop time tₛ (i.e., t=tₛ) determined in step S5. The processor 36 determines YES when the elapsed time t has reached the stop time tₛ and proceeds to step S7, while it determines NO when the elapsed time t has not reached the stop time tₛ (t<tₛ), and loops the step S6.

In step S7, the processor 36 resumes the emission of the laser beam L₁ from the resonator section 28 to the light-guiding member 24. As an example, the processor 36 sends a command to the laser power source 30 so as to resume the power supply from the laser power source 30 to the resonator section 28, thereby resuming the laser beam generation operation of the resonator section 28. As another example, if the laser oscillator 22 includes the above-described shutter, the processor 36 may open the shutter to resume the emission of the laser beam L₁ from the resonator section 28 to the light-guiding member 24.

The processor 36 stores in the memory 38 the position of the laser beam L₁ with respect to the workpiece W at the time point t₁ at which the emission of the laser beam L₁ is stopped in step S4, and in step S7, resumes the emission of the laser beam L₁ in a state where the laser beam L₁ disposed at the position stored in the memory 38 with respect to the workpiece W. Due to this, it is possible to prevent the quality of the laser-processing from being affected by stopping the emission of the laser beam L₁ in step S4.

In step S8, the processor 36 determines whether the laser-processing work is completed. For example, the processor 36 analyzes the computer program for laser-processing, and determines whether the laser-processing work being executed is completed. When the processor 36 determines that the laser-processing work is completed (i.e., determines YES), it stops the laser beam generation operation of the resonator section 28, and ends the flow illustrated in FIG. 2. On the other hand, when the processor 36 determines that the laser-processing work is not completed (i.e., NO), it returns to step S3.

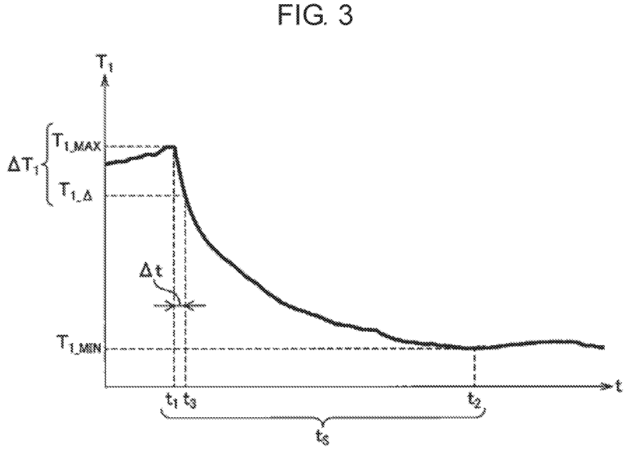

As described above, in the present embodiment, when the detection value T₁ exceeds the threshold Tₜₕ₁, the processor 36 determines the stop time tₛ based on the detection value T₁, and stops the emission of the laser beam L₁ from the resonator section 28 over the determined stop time tₛ. FIG. 3 illustrates a graph of a temporal change of the temperature T₁ of the light-guiding member 24 when the emission of the laser beam L₁ from the resonator section 28 is stopped over the stop time tₛ.

In the example illustrated in FIG. 3, it is assumed that the temperature T_{1_MAX} is detected at the time point t₁, based on which, it is determined YES in step S3, and the emission of the laser beam L₁ is stopped in step S4. As illustrated in FIG. 3, after the emission of the laser beam L₁ is stopped, the temperature T₁ rapidly decreases from the temperature T_{1_MAX}, and decreases to the temperature T_{1_MIN} at a time point t₂ at which the stop time tₛ has elapsed from the time point t₁ (t₂=t₁+tₛ).

In the example illustrated in FIG. 3, the temperature T_{1_MIN} is a value close to an equilibrium temperature at which the temperature T₁ decreases to reach an equilibrium state after the emission of the laser beam L₁ is stopped. As described above, by temporarily stopping the emission of the laser beam L₁ when the detection value (temperature) T₁ exceeds the threshold Tₜₕ₁, it is possible to prevent the light-guiding member 24 from being overheated and causing a defect (deformation, melting, or the like) in the light-guiding member 24. Further, by determining the stop time tₛ based on the detection value T₁, the stop time tₛ can be automatically determined as an optimum time for cooling the light-guiding member 24.

Further, in the present embodiment, the processor 36 obtains the stop time tₛ by performing the predetermined calculation using the detection value T₁. More specifically, as the predetermined calculation, the processor 36 calculates the heat amount Q and the heat dissipation amount J using the detected value T₁, and then calculates the stop time tₛ from the heat amount Q and the heat dissipation amount J. According to this configuration, the stop time tₛ can be quantitatively determined from the detection value T₁ as an optimum time for cooling the light-guiding member 24 as illustrated in FIG. 3 along with taking the heat dissipation by the cooling device 26 into account.

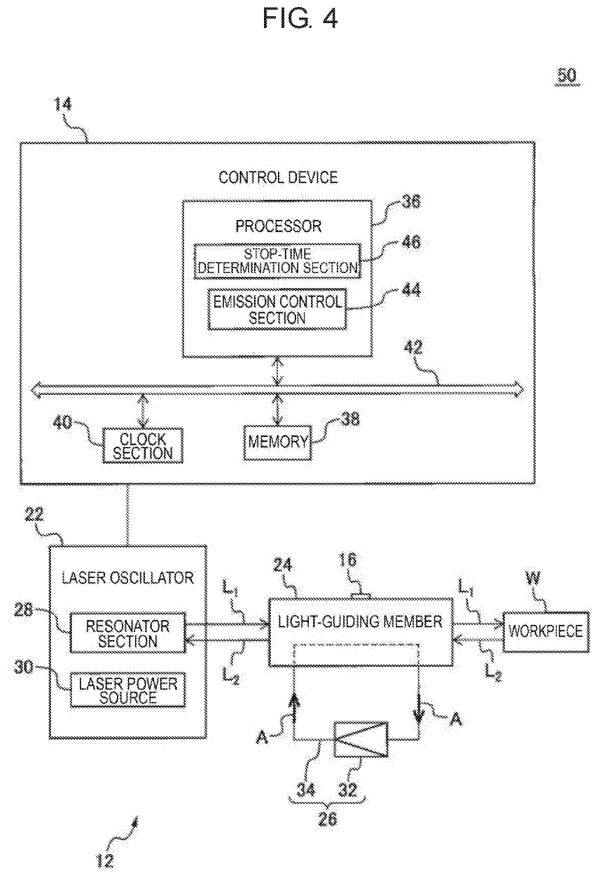

Next, a laser system 50 according to another embodiment will be described with reference to FIG. 4. The laser system 50 differs from the above-described laser system 10 in that it does not include the temperature sensors 18 and 20. Next, referring to FIG. 2, the operation of the laser system 50 will be described. The processor 36 of the laser system 50 executes the flow illustrated in FIG. 2.

The operation flow of the laser system 50 is different from that of the laser system 10 in step S5. Specifically, in step S5, the processor 36 of the laser system 50 functions as the stop-time determination section 46 to determine the stop time tₛ based on the most-recently acquired detection value T₁.

As an example, the memory 38 of the laser system 50 pre-stores a first data table indicating the relationship between the temperature T₁ of the light-guiding member 24 and the stop time tₛ. An example of the first data table is illustrated in Table 1 below.

| Temperature T₁ | Stop time tₛ |
|---|---|
| T₁_{_{—}}₁ | tₛ_{_{—}}₁ |
| T₁_{_{—}}₂ | tₛ_{_{—}}₂ |
| T₁_{_{—}}₃ | tₛ_{_{—}}₃ |
| . | . |
| . | . |
| . | . |
| T₁_{_{—}}ₙ | tₛ_{_{—}}ₙ |

As illustrated in Table 1, in the first data table, a plurality of stop times tₛ are stored in association with the temperature T₁. In this regard, the temperature-change characteristic when the temperature T₁ of the light-guiding member 24 changes from T_{1_MAX} to T_{1_MIN} as illustrated in FIG. 3 depends on the material of the light-guiding member 24. Therefore, the first data table can be created for each material of the light-guiding member 24 by an experimental method, a simulation, or the like.

In this step S5, the processor 36 applies the most-recently acquired detection value (temperature) T₁ to the first data table, and searches the stop time tₛ corresponding to the most-recently acquired detection value T₁ from the first data table. Thus, the processor 36 can determine the stop time tₛ from the detection value T₁.

As another example, instead of using the first data table, the processor 36 may estimate, from the most-recently acquired detection value T₁ and the material of the light-guiding member 24, a nonlinear function corresponding to the decreasing characteristic of the temperature T₁ within the interval between the time point t₁ and the time point t₂ in FIG. 3. The processor 36 may obtain the stop time tₛ from the nonlinear function.

As still another example, the processor 36 further acquires, as a detection value, a temperature T_{1_Δ} detected by the temperature sensor 16 at a time point t₃ when a predetermined time Δt has elapsed from the time point t₁ (i.e., t₃=t₁+Δt) as illustrated in FIG. 3. For example, the predetermined time Δt is set to coincide with the cycle time T₁ (or an integer multiple of the cycle time τ₁: nτ₁) by which the temperature sensor 16 repeatedly detects the temperature T₁.

Then, the processor 36 determines the stop time tₛ based on a degree of change (temperature gradient) in the detection value T₁ from the time point t₁ to the time point t₃. For example, the degree of change in the detection value T₁ is represented as an amount of change ΔT₁ in the detection value (temperature) T₁ from time t₁ to t₃ (i.e., ΔT₁=T_{1_MAX}−T_{1_Δ}), or as a gradient ΔT₁/Δt of the detection value T₁ from time t₁ to t₃ (i.e., ΔT₁/Δt=(T_{1_MAX}−T_{1_Δ})/(t₃−t₁)).

The memory 38 of the laser system 50 pre-stores a second data table indicating the relationship between the degree of change (ΔT₁ or ΔT₁/Δt) and the stop time tₛ. This second data table is similar to the first data table illustrated in Table 1, and in the second data table, a plurality of stop times tₛ are stored in association with the degree of change (ΔT₁ or ΔT₁/Δt). The second data table can be created for each material of the light-guiding member 24 by an experimental method, a simulation, or the like.

In step S5, the processor 36 obtains the degree of change (ΔT₁ or ΔT₁/Δt) from the detection values T₁ mx and T_{1_Δ} acquired from the temperature sensor 16, and applies the obtained degree of change (ΔT₁ or ΔT₁/Δt) to the second data table to search the corresponding stop time tₛ. In this way, the processor 36 can determine the stop time tₛ from the detection values T_{1_MAX} and T_{1_Δ}.

As still another example, instead of using the above-described second data table, the processor 36 may estimate a nonlinear function corresponding to the decreasing characteristic of the temperature T₁ within the interval between the time point t₃ and the time point t₂ in FIG. 3, from the above-described degree of change (ΔT₁ or ΔT₁/Δt) and the material of the light-guiding member 24. The processor 36 may obtain the stop time tₛ from the nonlinear function.

As described above, in the present embodiment, the processor 36 determines the stop time tₛ based on the detection value T₁ of the temperature sensor 16 and the data table or the nonlinear function. According to this embodiment, the stop time t₃ can be determined without the temperature sensors 18 and 20 described above.

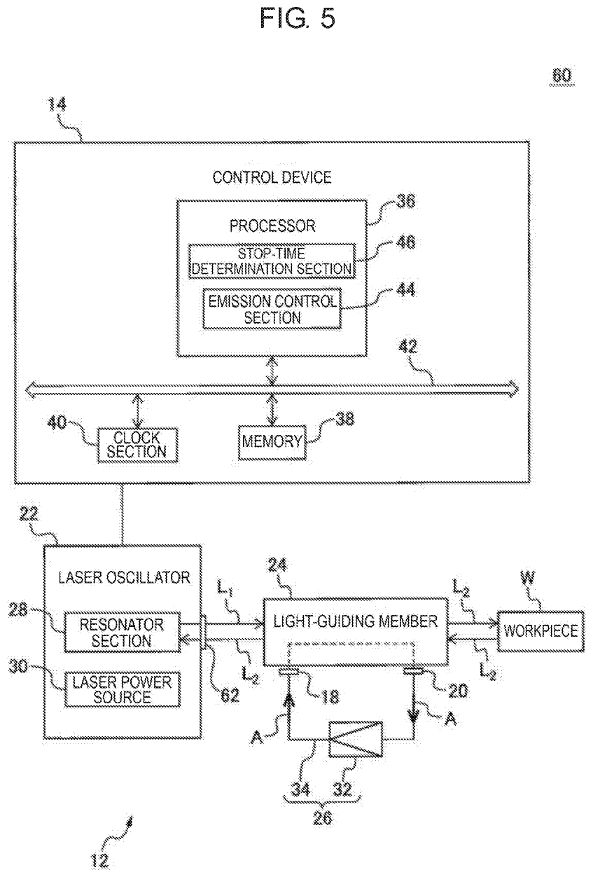

Next, a laser system 60 according to still another embodiment will be described with reference to FIG. 5. The laser system 60 is different from the above-described laser system 10 in the following configuration. Specifically, the laser system 60 does not include the temperature sensor 16, but includes the optical sensor 62.

The optical sensor 62 includes e.g. a photodiode configured to receive the laser beam L, and detects a magnitude M (e.g., laser intensity or laser power) of the laser beam L. In the present embodiment, the optical sensor 62 is disposed between the resonator section 28 and the light-guiding member 24, and detects as a detection value the magnitude M of the laser beam L (the laser beam L₁ and the return beam L₂) guided by the light-guiding member 24

Therefore, in the present embodiment, the optical sensor 62 constitutes a detection device configured to detect the magnitude M of the laser beam L as the detection value. Note that the optical sensor 62 may detect the magnitude M of one of the laser beam L₁ and the return beam L₂, or the optical sensor 62 may include a first optical sensor 62A that detects the magnitude M of the laser beam L₁ and a second optical sensor 62B that detects the magnitude M of the return beam L₂.

Next, the operation of the laser system 60 will be described with reference to FIG. 2. The processor 36 of the laser system 60 executes the flow illustrated in FIG. 2. The operation flow of the laser system 60 is different from that of the above-described laser system 10 in steps S2, S3, and S5.

In step S2, the processor 36 of the laser system 60 starts detection of a detection value M by the optical sensor 62. Specifically, the optical sensor 62 consecutively (e.g., periodically) detects the magnitude M of the laser beam L (the laser beam L₁, the return beam L₂) and sequentially transmits the magnitude M as the detection value M to the control device 14. The processor 36 stores in the memory 38 the detection value M acquired from the optical sensor 62.

In step S3, the processor 36 determines whether the most-recently acquired detection value M exceeds a predetermined threshold Mₜₕ (M≥Mₜₕ). The threshold Mₜₕ is determined by the operator and pre-stored in the memory 38. The processor 36 determines YES when M≥Mₜₕ is satisfied and proceeds to step S4, while it determines NO when M<Mₜₕ is satisfied and proceeds to step S8.

Alternatively, in step S3, the processor 36 may determine YES when the most-recently acquired detection value M continuously exceeds the threshold Mₜₕ over a predetermined time t_{M} after exceeding the threshold Mₜₕ. For example, the processor 36 causes the clock section 40 to start clocking an elapsed time t′ at the time when the most-recently acquired detection value M exceeds the threshold Mₜₕ.

Then, the processor 36 may monitor whether the detection value M continuously exceeds the threshold Mₜₕ until the elapsed time t′ reaches the predetermined time t_{M}, and may determine YES when the detection value M continuously exceeds the threshold Mₜₕ over the time t_{M}. The predetermined time t_{M} may be determined by an operator and pre-stored in the memory 38.

In step S5, the processor 36 functions as the stop-time determination section 46 to determine the stop time tₛ based on the most-recently acquired detection value M. Specifically, the processor 36 obtain the stop time tₛ by performing a predetermined calculation, using the detection value M. Hereinafter, a calculation method for obtaining the stop time t₃ will be described.

First, the processor 36 calculates from the detection value M the heat amount Q accumulated in the light-guiding member 24 by the laser beam L. In order to calculate the heat amount Q, the processor 36 first calculates a total light amount I of the laser beam L from the equation I=∫M(t)dt. In this regard, M(t) is a temporal change in the detection value M detected by the optical sensor 62 before the execution of step S4. For example, if the optical sensor 62 repeatedly detects the magnitude M by a cycle time τ₂, the integration time dt may be set as a time (nτ₂) that is an integer multiple of the cycle time τ₂. In this case, the total light amount I is an integrated value of the detection values M detected within the period of nτ₂.

Then, the processor 36 calculates, using the total light amount I, a heat input amount q to the light-guiding member 24 by the laser beam L as a function of the total light amount I, which is represented as q=f(I). Parameters of the function f(I) can be arbitrarily defined by an operator by an experimental method, simulation, or the like. For example, the function f(I) can be defined as a function including the time t and the total light amount I as the parameters.

Together with the heat input amount q, the processor 36 calculates the heat dissipation amount J (=∫[C_{C}×(T₃−T₂)]dt) of the light-guiding member 24 by the cooling device 26, using the temperature T₂ detected by the temperature sensor 18 and the temperature T₃ detected by the temperature sensor 20, similarly to the laser system 10 described above. Then, the processor 36 calculates the heat amount Q from the equation Q=q−J (=f(I)−∫[C_{C}×(T₃−T₂)]dt), using the heat input amount q and the heat dissipation amount J.

Then, the processor 36 calculates the stop time tₛ from an equation of tₛ=Q/J (=(q−J)/J=f(I)/J[C_{C}×(T₃−T₂)]dt−1), using the heat amount Q and the heat dissipation amount J. In this manner, the processor 36 obtains and determines the stop time tₛ by calculation described above. Note that the calculation of the stop time tₛ is not limited to the example using the above-described equation, but may be performed using any other equation. The equation used for calculating the stop time tₛ can be arbitrarily defined by the operator.

As described above, in the present embodiment, the processor 36 of the laser system 60 obtains the stop time tₛ by performing a predetermined calculation using the detection value (magnitude) M. According to this configuration, it is possible to quantitatively determine the stop time tₛ from the detection value M as an optimum time for cooling the light-guiding member 24, while taking the heat dissipation by the cooling device 26 into consideration.

Note that the processor 36 of the laser system 60 may calculate the temperature T₁ of the light-guiding member 24 from the magnitude M of the return beam L₂ detected by the optical sensor 62. Hereinafter, another example of the operation of the laser system 60 will be described with reference to FIG. 2. In step S2, the processor 36 starts detecting the detection value T₁.

Specifically, the optical sensor 62 consecutively detects the magnitude M of the return beam L₂, and the processor 36 sequentially acquires data of the magnitude M from the optical sensor 62. Every time the processor 36 obtains the magnitude M, it calculates the heat input amount q (q=f(I)) from the magnitude M and the heat dissipation amount J (=∫[C_{C}×(T₃−T₂)]dt) from the temperatures T₂ and T₃, by the above-described calculation methods.

Then, the processor 36 calculates the temperature T₁ of the light-guiding member 24 from the equation T₁=(q−J)/C_{G} (=(f(I)−∫[C_{C}×(T₃−T₁)]dt)/C_{G}), using the heat input amount q, the heat dissipation amount J, and the heat capacity C_{G} of the light-guiding member 24. In this manner, the processor 36 detects the temperature T₁ of the light-guiding member 24 as the detection value, using the magnitude M of the return beam L₂ detected by the optical sensor 62. Therefore, in this embodiment, the optical sensor 62 and the processor 36 constitute a detection device configured to detect the detection value T₁.

In step S3, the processor 36 determines whether the most-recently acquired detection value T₁ exceeds a threshold Tₜₕ₁ (T₁≥Tₜₕ₁). The processor 36 determines YES when T₁≥Tₜₕ₁ is satisfied and proceeds to step S4, while it determines NO when T₁<Tₜₕ₁ is satisfied and proceeds to step S8. According to the present embodiment, the detection value T₁ can be detected based on the magnitude M of the return beam L₂ detected by the optical sensor 62, without the above-described temperature sensor 16. In addition, since the detection value T₁ can be detected at a higher speed than in the case where the detection value T₁ is detected by the temperature sensor 16, it is possible to execute the flow illustrated in FIG. 2 at a higher speed.

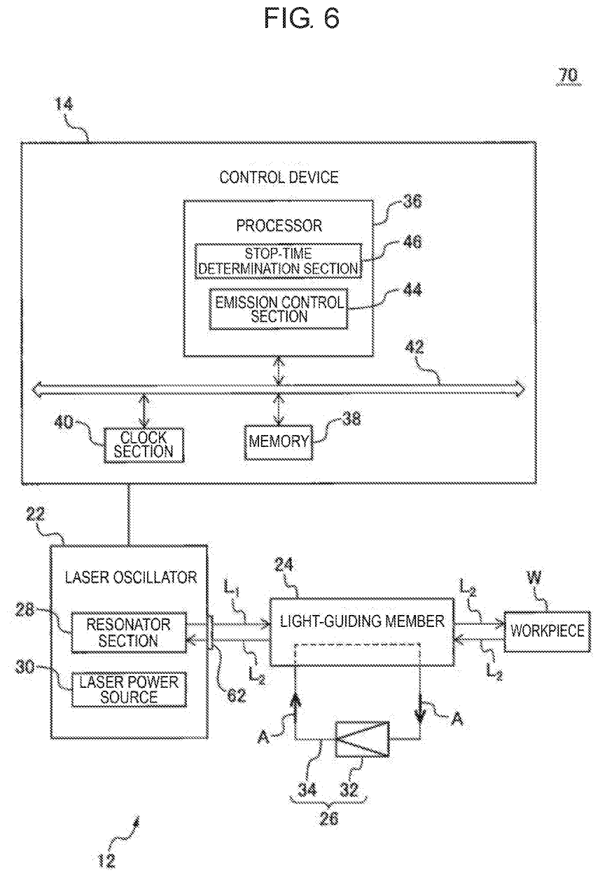

Referring now to FIG. 6, a laser system 70 according to yet another embodiment is described. The laser system 70 differs from the above-described laser system 60 in that it does not include the temperature sensors 18 and 20. Next, the operation of the laser system 70 will be described with reference to FIG. 2.

The operation flow of the laser system 70 is different from that of the above-described laser system 10 in steps S2, S3 and S5. In step S2, the processor 36 of the laser system 70 starts detecting the detection value T₁. Specifically, the processor 36 detects the temperature T₁ (T₁=(q−J)/C_{G}) of the light-guiding member 24 as the detection value T₁ by calculation every time the optical sensor 62 detects the magnitude M of the laser beam L, similarly as in the other example of the operation of the laser system 60 described above.

In step S3, the processor 36 determines whether the most-recently acquired detection value T₁ exceeds the threshold Tₜₕ₁ (T₁≥Tₜₕ₁) similarly as in the other example of the operation of the laser system 60 described above. Then, in step S5, the processor 36 functions as the stop-time determination section 46 to determine the stop time tₛ based on the most-recently acquired detection value T₁, similarly as the laser system 50 described above.

As an example, the processor 36 applies the most-recently acquired detection value T₁ to the first data table shown in above Table 1, and searches for the stop time tₛ corresponding to the most-recently acquired detection value T₁ from the first data table. As another example, the processor 36 estimates, from the most-recently acquired detection value T₁ and the material of the light-guiding member 24, the nonlinear function corresponding to the decreasing characteristic of the temperature T₁ within the interval between the time point t₁ and the time point t₂ in FIG. 3, and obtains the stop time t from the nonlinear function.

Thus, in the present embodiment, the processor 36 determines the stop time tₛ based on the detection value T₁ acquired from the magnitude M of the laser beam L, and the data table or the nonlinear function. According to this configuration, the stop time tₛ can be determined without the temperature sensors 16, 18 and 20 described above.

It should be noted that the features of the above-described laser systems 10, 50, 60 and 70 may be combined. For example, the laser system 10 may further include an optical sensor 62, wherein the processor 36 may execute steps S2, S3 and S5 in the same manner as the operation flow of the laser system 50, 60 and 70.

In this case, in step S3, the temperature sensor 16 may detect the temperature T₁ as a first detection value, and the optical sensor 62 may detect the magnitude M as a second detection value. Then, the processor 36 may determine whether the detection value T₁ or M exceeds the threshold in step S3, and determine the stop time tₛ based on the detection value T₁ or M in step S5. Therefore, in this case, the temperature sensor 16 and the optical sensor 62 constitute a detection device.

Note that above-described step S5 may not necessarily be executed after step S4. For example, in the embodiments in which the stop time tₛ is determined not based on the degree of change (ΔT₁ or ΔT₁/Δt), step S5 may be executed simultaneously with or before step S4. In the laser systems 10 and 60 described above, the heat dissipation amount J is obtained by the calculation (J=∫[C_{C}×(T₃−T₂)]dt), however, the heat dissipation amount J may be defined as a constant value in accordance with the specification of the cooling device 26.

In the laser systems 10 and 50 described above, the temperature sensor 16 detects the detection value T₁, and the processor 36 determines in step S3 whether the detection value T₁ exceeds the threshold Tₜₕ₁. However, the temperature sensor 16 may be a temperature switch that detects the detection value T₁ and transmits an ON signal to the processor 36 when the detection value T₁ exceeds the threshold Tₜₕ₁. In this case, the processor 36 determines YES in step S3 when the output signal from the temperature sensor 16 is ON.

In the laser systems 10, 50, 60 and 70 described above, the processor 36 resumes the emission of laser beam from the resonator section 28 in step S7. However, the processor 36 may maintain a state in which the emission of the laser beam is stopped, depending on a predetermined condition.

For example, if other operation information of the laser device 12 (the coolant flow rate in the coolant flow path 34, the laser output value of the laser beam L₁, etc.) different from the detection values T₁ and M does not indicate a normal operation state (e.g., out of an allowable range), the processor 36 may maintain a state in which the emission of the laser beam L₁ from the resonator section 28 is stopped without executing step S7 even when it is determined YES in step S6.

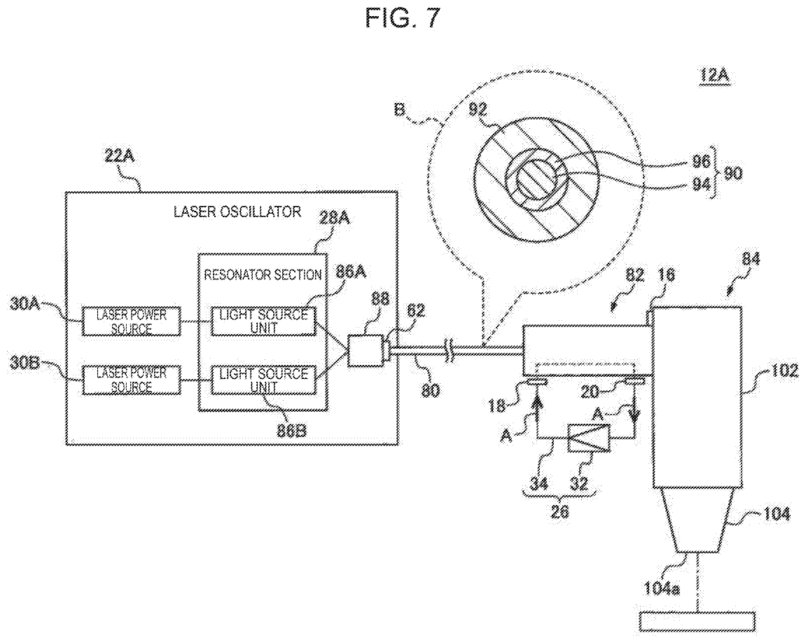

Note that there are various types of laser devices 12 described above. Hereinafter, an embodiment of the laser device 12 will be described with reference to FIG. 7. The laser device 12A illustrated in FIG. 7 includes a laser oscillator 22A, a cooling device 26, an optical fiber 80, a connecting member 82, and a processing head 84.

The laser oscillator 22A is a solid-state laser oscillator, and includes a resonator section 28A, laser power sources 30A and 30B, and a beam combiner 88. The resonator section 28A includes a plurality of light source units 86A and 86B each of which includes a laser diode that emits laser beam.

Each of the light source units 86A and 86B amplifies the laser beam emitted from the laser diode by optical resonance, and outputs the amplified laser beam to the beam combiner 88. The laser power sources 30A and 30B supply power for the laser beam generation operation to the light source units 86A and 86B, respectively, in accordance with a command from the control device 14. The beam combiner 88 combines the laser beams output from the light source units 86A and 86B, and emits the combined laser beam as the laser beam L₁ to the optical fiber 80.

The optical fiber 80 guides the laser beam L₁ generated by the resonator section 28A to the connecting member 82. Specifically, as illustrated in section B in FIG. 7, the optical fiber 80 includes a core line 90 and a sheath 92 covering the outer periphery of the core line 90. The core line 90 includes a core 94 and a clad 96 disposed concentrically with the core 94 so as to cover the outer periphery of the core 94. The laser beam L₁ emitted from the beam combiner 88 is incident on the core 94 and propagates through the core 94 toward the connecting member 82. The optical fiber 80 is connected to the connecting member 82.

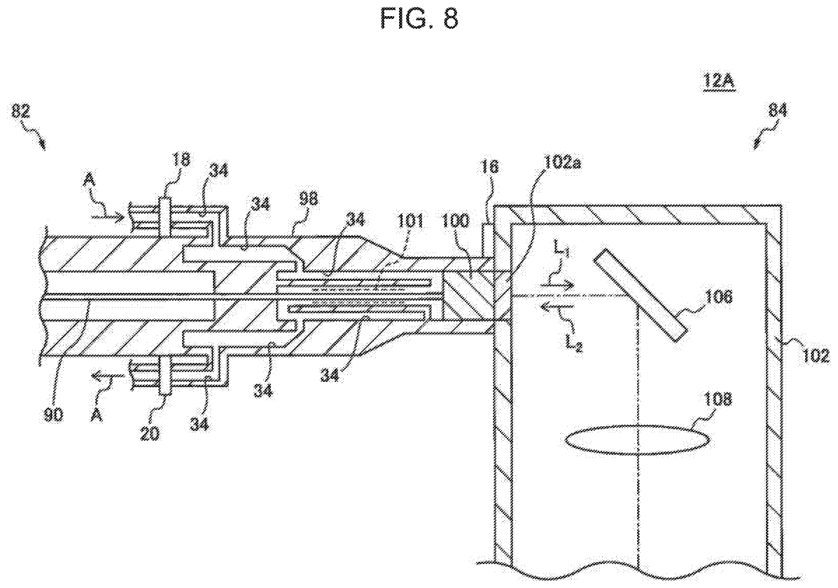

The connecting member 82 guides the laser beam L₁ propagating through the optical fiber 80 to the processing head 84. Hereinafter, the connecting member 82 will be described with reference to FIG. 8. The connecting member 82 includes a hollow main body 98 and a light guide body 100 disposed inside the main body 98. The optical fiber 80 is connected to a proximal end of the main body 98, while a distal end of the main body 98 is coupled to the processing head 84.

In the optical fiber 80 connected to the proximal end of the main body 98, the sheath 92 terminates at the proximal end of the main body 98, while the core line 90 passes through the inside of the main body 98 and is connected (e.g., fused) to the light guide body 100 at the distal end of the core line 90. A mode-stripper 101 is provided at the outer peripheral side of core line 90 passing through the inside of the main body 98.

The mode-stripper 101 has a convex and concave shape, and diffuses the return beam L₂ propagating in the clad 96 of the core line 90 so as to attenuate the return beam L₂. The laser beam L₁ propagated through the core 94 of the core line 90 is incident on the light guide body 100 and propagates through the light guide body 100 toward the processing head 84. The light guide body 100 is made of e.g. quartz, and disposed at the distal end portion of the main body 98.

A part of the coolant flow path 34 of the cooling device 26 is formed in the main body 98. The coolant, which flows through the coolant flow path 34 in the direction of arrow A by the flow device 32, flows into the main body 98, passes through the main body 98, and then flows out of the main body 98. The main body 98 and the light guide body 100 are cooled by the thus-flowing coolant.

The processing head 84 guides the laser beam L₁ incident from the connecting member 82 and irradiates the workpiece W with the laser beam L₁. Specifically, as illustrated in FIGS. 7 and 8, the processing head 84 includes a head body 102, a nozzle 104, a reflection mirror 106, and an optical lens 108. The head body 102 is hollow and holds the reflection mirror 106 and the optical lens 108 therein.

The distal end of the main body 98 of the connecting member 82 is fixed to the head body 102. A light receiving portion 102a is provided in the head body 102 at a connection between the head body 102 and the main body 98. The light receiving portion 102a receives the laser beam L₁ propagated through the light guide body 100 and guides the laser beam L₁ toward the reflection mirror 106.

The reflection mirror 106 is e.g. a total reflection mirror, and reflects the laser beam L₁ from the light receiving portion 102a toward the optical lens 108. The optical lens 108 includes e.g. a focus lens, and focuses the laser beam L₁ from the reflection mirror 106 so as to irradiates the workpiece W with the focused laser beam L₁. The nozzle 104 is hollow and includes an emission port 104a. The laser beam L₁ focused by the optical lens 108 is emitted from the emission port 104a toward the workpiece W.

As described above, the laser beam L₁ generated by the resonator section 28A is guided by the beam combiner 88, the optical fiber 80, the connecting member 82, and the processing head 84, and is irradiated onto the workpiece W. Therefore, the components of each of the beam combiner 88, the optical fiber 80, the connecting member 82, and the processing head 84 constitute the above-described light-guiding member 24.

A part of the laser beam L₁ irradiated onto the workpiece W₁ is reflected by the surface of the workpiece W₁, and propagates toward the resonator section 28A as the return beam L₂. Specifically, the return beam L₂ propagates through the optical lens 108, the reflection mirror 106, and the light guide body 100, and is incident on the core line 90 of the optical fiber 80. Since the return beam L₂ is scattered light, the return beam L₂ is incident on the clad 96 of the core line 90 and propagates through the clad 96 toward the resonator section 28A.

As illustrated in FIG. 8, the temperature sensor 18 is provided at a position on the upstream of the main body 98 in the coolant flow path 34, and detects the temperature T₂ of the coolant flowing into the main body 98. On the other hand, the temperature sensor 20 is provided at a position on the downstream of the main body 98 in the coolant flow path 34, and detects the temperature T₃ of the coolant flowing out of the main body 98. The temperature sensor 16 is provided at the main body 98 or the head body 102 so as to be adjacent to the light guide body 100, and detects the temperature T₁ of the connecting member 82 (specifically, the light guide body 100).

Further, as illustrated in FIG. 7, the optical sensor 62 is disposed between the beam combiner 88 and the optical fiber 80. The return beam L₂ propagating through the clad 96 toward the resonator section 28A causes heat generation in the optical fiber 80 and the connecting member 82 (e.g., a coupling portion between the light guide body 100 and the core line 90, or the mode-stripper 101). In the present embodiment, the optical sensor 62 is configured to detect the magnitude M of the return beam L₂ propagating through the clad 96 in order to prevent the light-guiding member from being overheated by the return beam L₂. However, the optical sensor 62 may be configured to detect the laser beam L₁.

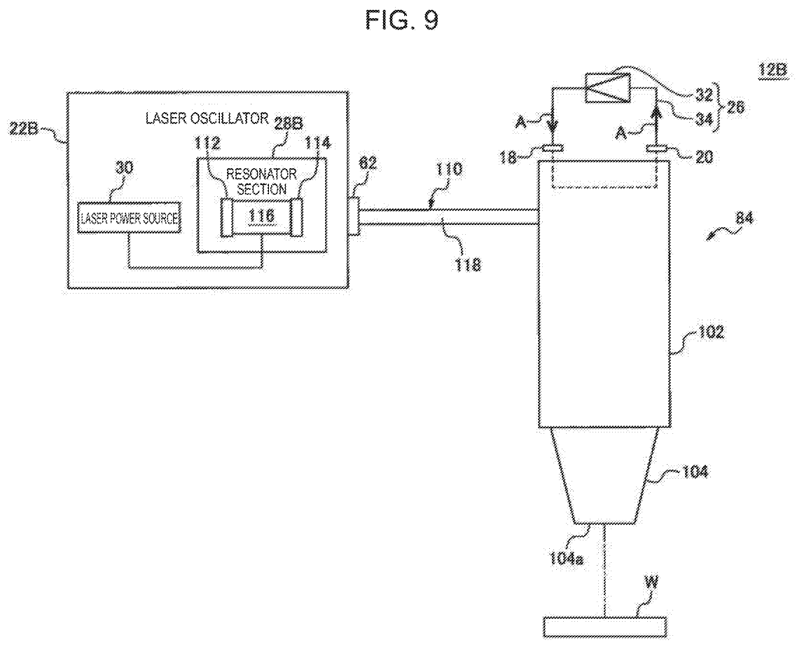

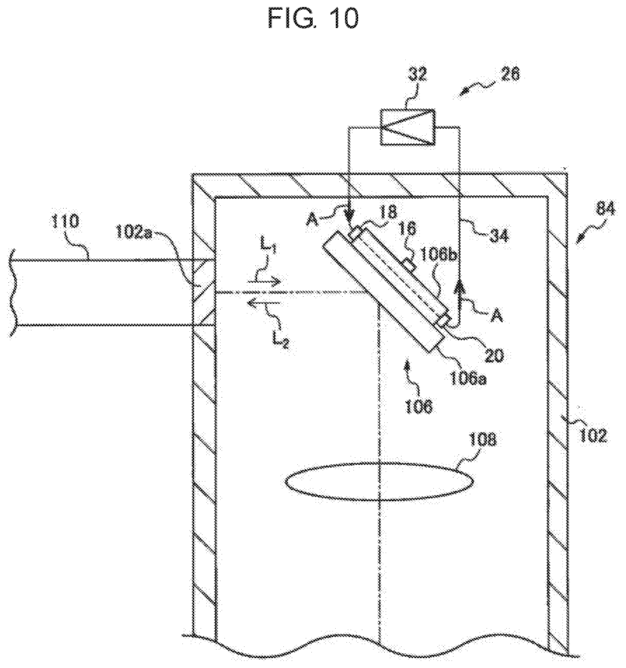

Next, another embodiment of the laser device 12 will be described with reference to FIGS. 9 and 10. A laser device 12B illustrated in FIGS. 9 and 10 includes a laser oscillator 22B, the cooling device 26, a light guide structure 110, and the processing head 84. The laser oscillator 22B is a gas laser oscillator, and includes a resonator section 28B and the laser power source 30.

The resonator section 28B includes a rear mirror 112, an output mirror 114, and a discharge tube 116. The rear mirror 112 is a total reflection mirror, while the output mirror 114 is a partial reflection mirror, wherein the rear mirror 112 and the output mirror 114 are disposed opposite to each other. The discharge tube 116 is hollow, and a laser medium (e.g., CO₂) is supplied to the inside thereof. The discharge tube 116 receives power supply from the laser power source 30, and generates electric discharge inside thereof so as to excite the laser medium to generated a laser beam. The laser beam generated in the discharge tube 116 optically resonates between the rear mirror 112 and the output mirror 114, and is emitted from the output mirror 114 as the laser beam L₁.

The light guide structure 110 guides the laser beam L₁ emitted from the output mirror 114 to the processing head 84. The light guide structure 110 includes a housing 118 that defines a hollow light guide path through which the laser beam L₁ propagates, and a reflection mirror (not illustrated) disposed inside the housing 118 and reflects the laser beam L₁ in a predetermined direction.

As illustrated in FIG. 10, the laser beam L₁ guided by the light guide structure 110 is incident on the light receiving portion 102a of the processing head 84, and guided toward the reflection mirror 106. In this manner, the laser beam L₁ generated by the resonator section 28B is guided by the light guide structure 110 and the processing head 84 and is irradiated onto the workpiece W. Therefore, the components of the light guide structure 110 and the processing head 84 constitute the above-described light-guiding member 24.

In the present embodiment, the reflection mirror 106 includes a mirror main body 106a and a bracket 106b provided on the back side of the mirror main body 106a. A part of the coolant flow path 34 of the cooling device 26 is formed in the bracket 106b. The coolant, which is flown by the flow device 32 in the direction of arrow A through the coolant flow path 34, flows into, passes through and flows out of the bracket 106b. The reflection mirror 106 is cooled by the coolant flowing in this manner.

The temperature sensor 18 is provided at a position on the upstream of bracket 106b in the coolant flow path 34, and detects the temperature T₂ of the coolant flowing into the bracket 106b. On the other hand, the temperature sensor 20 is provided at a position on the downstream of bracket 106b in the coolant flow path 34, and detects the temperature T₃ of the coolant flowing out of the bracket 106b.

The temperature sensor 16 is provided on the bracket 106b and detects the temperature T₁ of the reflection mirror 106. As illustrated in FIG. 9, the optical sensor 62 is disposed between the resonator section 28B and the light guide structure 110. The optical sensor 62 is configured to detect the magnitude M of at least one of the laser beam L₁ and the return beam L₂. It should be understood that, in the laser device 12A or 12B described above, the cooling device 26 and the temperature sensors 16, 18 and 20 may be provided at any other light-guiding member (e.g., the optical lens 108).

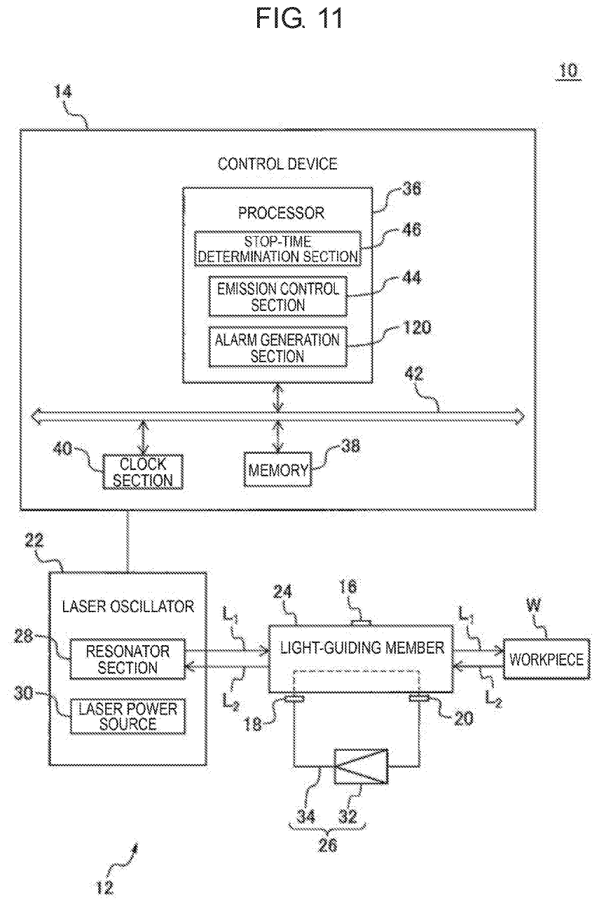

In the laser systems 10, 50, 60 and 70 described above, the processor 36 may generate an alarm when determining YES in above step S3. Hereinafter, such an embodiment will be described with reference to FIGS. 2 and 11. In the laser system 10, when it is determined YES in step S3, the processor 36 generates an alarm signal indicating that “Light-guiding member may become overheated state” in the form of sound or an image, for example. Then, the processor 36 outputs the generated alarm signal through a speaker or a display (both not illustrated) provided at the control device 14. Thus, the processor 36 functions as an alarm generation section 120 configured to generate the alarm signal.

Note that, if the processor 36 receives a laser emission command from an operator, a host controller or a computer program while it continuously determines NO in step S6 so as to loop step S6 (i.e., while continuing to stop the emission of the laser beam L₁), the processor 36 may function as the alarm generation section 120 to generate a second alarm signal indicating that the laser beam emission should be suspended for cooling the light-guiding member 24.

The processor 36 of the laser system 10, 50, 60 or 70 may generate a remaining-time signal indicative of a remaining time tₐ (=tₐ−t) until the elapsed time t clocked by the clock section 40 reaches the stop time tₛ, after step S5. Then, the processor 36 may display the remaining time t_{R} on a display provided at the control device 14, for example. According to this configuration, the operator can intuitively understand the timing at which the stop of emitting the laser beam L₁ from the resonator section 28 is released.

The processor 36 of the laser system 10, 50, 60 or 70 may control an operation mode OM of the laser oscillator 22 (resonator section 28) in response to the stop time t₃ determined in step S5. For example, the processor 36 may control the operation mode OM to a standard-standby mode OM₁ when the determined stop time t is equal to or shorter than a predetermined threshold, while it may control the operation mode OM to the energy-saving mode OM₂ when the stop time t₅ is longer than the predetermined threshold.

The standard-standby mode OM₁ is e.g. an operation mode in which the emission of the laser beam L₁ from the resonator section 28 is stopped, but the power supply from the laser power source 30 to the resonator section 28 is partially continued so that the resonator section 28 can quickly resume the emission of the laser beam L₁. On the other hand, the energy-saving mode OM₂ is an operation mode in which the power supply from the laser power source 30 to the resonator section 28 is completely cut off (i.e., set to zero).

The power consumption of the laser oscillator 22 in the standard-standby mode OM₁ is larger than that in the energy-saving mode OM₂. By thus-controlling the operation mode OM of the laser oscillator 22 in response to the stop time tₛ determined in step S5, it is possible to optimize the power consumption of the laser oscillator 22 and the time until the emission of the laser beam L₁ is resumed.

The processor 36 may detect the temperature T₂ detected by the temperature sensor 18 as a detection value, instead of the detection value T₁ detected by the temperature sensor 16 described above. In this case, the processor 36 starts detecting the detection value T₂ in step S2, and executes step S3 based on the detection value T₂. Then, in step S3, the processor 36 determines the stop time tₛ based on the detection value T₂.

For example, the processor 36 may determine the stop time tₛ based on the detection value T₂ and on a predetermined calculation, a data table (first data table, second data table), or a nonlinear function. While the present disclosure has been described through the embodiments, the above-described embodiments do not limit the invention according to the claims.

1. A laser system comprising:
a laser device including a resonator section configured to generate a laser beam, and a light-guiding member configured to guide the laser beam generated by the resonator section;
a detection device configured to detect, as a detection value, a temperature of the laser device or a magnitude of the laser beam guided by the light-guiding member;
an emission control section configured to stop emission of the laser beam from the resonator section to the light-guiding member when the detection value exceeds a predetermined threshold; and
a stop-time determination section configured to determine a stop time for causing the emission control section to stop the emission of the laser beam, based on the detection value detected by the detection device.

2. The laser system of claim 1, wherein the stop-time determination section is configured to obtain the stop time by performing a predetermined calculation using the detection value detected by the detection device.

3. The laser system of claim 2, wherein the laser device further includes a cooling device configured to cool the light-guiding member,
wherein, as the predetermined calculation, the stop-time determination section is configured to calculate:
a heat amount accumulated in the light-guiding member due to the laser beam, from the detection value detected by the detection device; and
the stop time, using a heat dissipation amount of the light-guiding member by the cooling device and the heat amount.

4. The laser system of claim 3, wherein the cooling device includes:
a coolant flow path provided at the light-guiding member; and
a flow device configured to cause a coolant to flow in the coolant flow path,
wherein the laser system further comprises a temperature sensor configured to detect a temperature of the coolant flowing through the coolant flow path,
wherein, as the predetermined calculation, the stop-time determination section is configured to further calculate the heat dissipation amount, using the temperature detected by the temperature sensor.

5. The laser system of claim 1, wherein the detection device is configured to detect the temperature as the detection value,
wherein the stop-time determination section is configured to determine the stop time based on a degree of change in the detection value detected by the detection device after the emission control section stops the emission of the laser beam.

6. The laser system of claim 1, wherein the light-guiding member includes:
an optical fiber configured to propagate the laser beam therethrough; and
a connecting member to which the optical fiber is connected,
wherein the detection device is configured to detect the temperature of the connecting member as the detection value.

7. The laser system of claim 1, wherein the light-guiding member includes an optical fiber configured to propagate the laser beam therethrough,
wherein the detection device is configured to detect, as the detection value, the magnitude of a return beam propagating toward the resonator section among the laser beam propagating through the optical fiber.

8. The laser system of claim 1, wherein the emission control section is configured to resume the emission of the laser beam after stopping the emission of the laser beam until the stop time determined by the stop-time determination section elapses.

9. The laser system of claim 1, further comprising an alarm generation section configured to generate an alarm signal when the detection value exceeds the threshold.

10. A method of controlling a laser device including a resonator section configured to generate a laser beam and a light-guiding member configured to guide the laser beam generated by the resonator section, the method comprising:
detecting, as a detection value, a temperature of the laser device or a magnitude of the laser beam guided by the light-guiding member;
stopping emission of the laser beam from the resonator section to the light-guiding member when the detection value exceeds a predetermined threshold; and
determining a stop time for stopping the emission of the laser beam from the resonator section, based on the detected detection value.
